(19) United States
(12) Patent Application Publication
(10) Pub. No.: US 2015/0026082 A1
(43) Pub. Date: Jan. 22, 2015

(54) Process for Automating Compliance with Know Your Customer Requirements

(71) Applicant: On Deck Capital, Inc., New York, NY (US)

(72) Inventors: Nikhil Phadnis, New York, NY (US); Eli Entin, New York, NY (US); Austin Ogilvie, New York, NY (US); Greg Lamp, New York, NY (US)

(21) Appl. No.: 14/336,631

(22) Filed: Jul. 21, 2014

Related U.S. Application Data
(60) Provisional application No. 61/856,183, filed on Jul. 19, 2013.

(51) Int. Cl. G06Q 30/00; G06Q 50/26

(52) U.S. Cl. CPC G06Q 30/018; G06Q 50/265
USPC 705/317

(57) ABSTRACT

The disclosure relates to a process for verifying the identity of the user submitting information to an online application portal for a business and verifying that he is a legal representative of that business. Using the process, a lender can calculate scores, which will allow a lender to verify with some certainty that the user is authorized to submit the application. This verification is necessary for compliance with lending regulations. The disclosure is directed toward loan transactions for small businesses.

### CROSS REFERENCE TO RELATED APPLICATIONS

This is a non-provisional which claims priority to U.S. Provisional Application No. 61/856,183, filed on Jul. 19, 2013, the entirety of which is hereby incorporated by reference.

### FIELD OF THE INVENTION

The disclosed embodiments relate generally to a process for verifying customer information in order to quickly and efficiently comply with Know Your Customer (“KYC”) requirements.

### BACKGROUND

Know Your Customer (“KYC”) refers to due diligence activities that financial institutions and other regulated companies must perform to ascertain relevant information from their clients for the purpose of doing business with them. Compliance with KYC regulations may place significant cost and administrative burdens on financial institutions.

Technology has changed the landscape of the financial services industry such that agents play an increasingly shrinking role in marketing the financial products to potential borrowers. As the Internet has grown in popularity, potential borrowers shop for financial services over the Internet without the aid of an agent. A growing number of online companies also provide loan services; however, these online companies currently fall short of fully automating the loan process. In the case of financial institutions, potential borrowers can apply for loans or other financial services online; however, the loan approval process still requires the involvement of an agent. Third party providers of financial services can provide a list of available financial services based on criteria provided by the potential borrower, but the potential borrower must still contact the financial services agency directly or await a contact by an agent of the financial services agency.

A large percentage of these potential borrowers are the owners of small businesses. Small businesses encounter a number of unique challenges when trying to secure financing. In order to meet the KYC requirements, it must be established that the user submitting the information is who they say they are and is in fact a legal representative of the business. The present invention addresses this issue by providing a method for querying multiple data sources in order to calculate at least three different scores to verify information. Additional verification is provided by answers to mandatory questions based on data sources. cl SUMMARY

The present invention includes systems and methods that provide tools for complying with the obligations of the USA Patriot Act (USAPA), in particular the obligations of financial institution to carry out a duly diligent investigation of new customers. The present invention addresses the needs of lenders by creating a method which helps verify information about a user which is necessary both to make business decision and also to comply with regulations. Utilizing the present invention allows a lender to verify that a user is authorized to submit a loan application for a business. The following definitions apply to the description of the preferred embodiment.

User: Entity submitting an application through an online loan application portal.

Consumer: Entity whose information is submitted to the portal as being the owner of the small business.

Business: Entity whose information is submitted to the portal such that loan will be issued under the name of that small business.

In one embodiment, the present invention relates to a process for establishing that a User submitting a loan application is representing the Consumer and is a legal representative of the Business comprising: receiving basic information about the Consumer and the Business, querying multiple data sources in order to obtain records on the legal representative of the Business, the Consumer, and the Business, calculating a score which predicts the likelihood of the Consumer being the legal representative of the Business, calculating a second score which predicts the likelihood that the consumer data elements submitted correspond to the Consumer; calculating a third score which predicts the likelihood that the business data elements submitted correspond the Business; prompting the User to answer questions about the Consumer and the Business, and evaluating the three scores and the answers to the questions to verify that the User is representing the Consumer and is a legal representative of the Business. If the User fails to pass, verification further steps are taken comprising: searching the User's IP address against a list of IP addresses known to have multiple online loan applications in a predetermined period of time, failing the loan application if too many online applications have previously failed, allowing the User to edit the information if the User has not submitted too many failing applications.

In certain embodiments, the loan application information is received via a network from the loan applicant's computing system. This network can be, among other things, the Internet. The data sources which are queried can include the following sources: EQUIFAX, PAYNET, CORTERA, DUN AND BRADSTREET, EXPERIAN, TRANSUNION, LEXIS NEXIS, PACER, IDOLOGY, VERID, and ID ANALYTICS as well as internal databases.

### DETAILED DESCRIPTION

The present invention relates to a method for verifying whether a User who is submitting an online loan application on behalf of a Business is in fact the legal representative of both the Consumer and the Business. The system compares various types of the potential borrower's information, such as name and address with corresponding categories of information from a variety of available data sources that contain public information on the Consumer and the Business. The information from the borrower and from the data sources is loaded, processed, and compared using comparison metrics specific to each category of information. This results in a score for that particular category of information. The scores from the various categories are then assessed together, along with answers to questions posed to the User, to determine whether the scores indicate that the information obtained is sufficiently likely to verify the ability of the User to secure a loan for the Business.

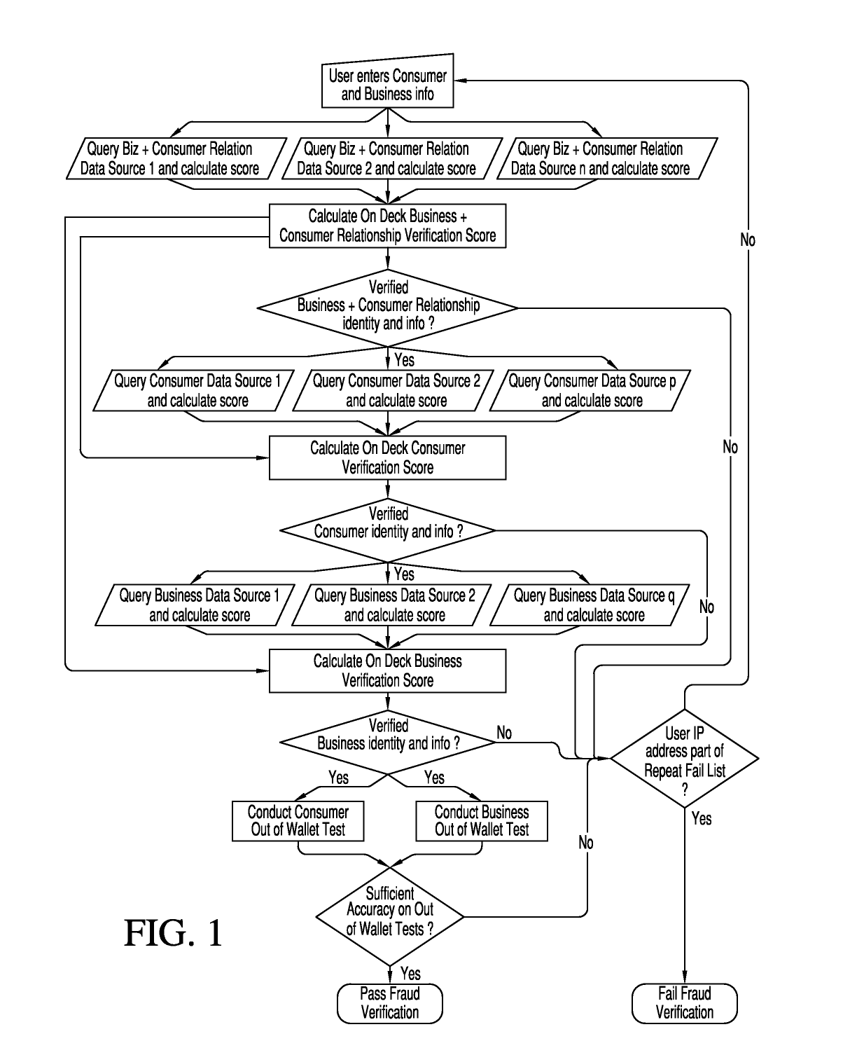

FIG. 1 shows a flow chart of one embodiment of an online method of verifying that a User is the legal representative of the Consumer and the Business. The process begins with a User entering Consumer and Business Information. The User might enter the information into a computer terminal connected to a network such as the internet to interface with the entity seeking to verify the User, such as through a webpage. Consumer Information may include name, address, telephone number, or Social Security Number. Business Information may include legal name, address, telephone number, or Business Tax ID number.

Using the Consumer and Business Information, multiple data sources are queried in order to obtain records on the legal representatives of the Business. The data sources might be queried using electronic services available over the internet. Business data sources may include, but are not limited to, EXPERIAN, EQUIFAX, PAYNET, CORTERA, and DUN AND BRADSTREET. Consumer data sources may include, but are not limited to EXPERIAN, EQUIFAX and TRANSUNION. Business and Consumer Relation Data Sources may include, but are not limited to, LEXIS NEXIS and PACER.

For each data source relied upon, a Business+Consumer Relationship score is calculated. The scores represent the Consumer's ability to act on behalf of the Business as evidenced by that particular data source. Based on the aggregation of those scores, an n-dimensional Business+Consumer Relationship Verification score is determined The Business+Consumer Relationship Verification score predicts the likelihood of the Consumer being an authorized representative of the Business. Minimum qualification limits are set on this score, which are based on historical fraud instances. A comparison of the minimum qualification limits with the Business+Consumer Relationship Verification score determines if the User passes this step.

If the User passes this step and the Business+Consumer relationship is verified, the process moves on to the next step. The next step queries multiple data sources in order to obtain records on the Consumer. The process then calculates an n-dimensional Consumer Verification score which predicts the likelihood that the consumer data elements submitted correspond to a singular entity (the Consumer). This score is a combination of data elements pulled during Consumer Verification as well as those pulled earlier during Business+Consumer verification. Minimum qualification limits set on this score determine if the User has submitted Consumer information accurately and if the User passes this step.

If the User passes this step, the process moves on to the next step which is the verification of Business information. This step queries multiple data sources in order to obtain records on the Business. From these an n-dimensional Business Verification score is calculated, which predicts the likelihood that the Business information submitted corresponds to an active and current business entity (the Business). Minimum qualification limits set on this score determine if the User has submitted Business information accurately and if application passes this step.

If the User passes this step, the next step is the verification of the relationship between User and Consumer/Business. In order to complete this step, multiple data sources are queried, including, but not limited to, IDology, VerID, ID Analytics, Electronic Verification systems, and internal databases. Based on these data sources, questions are created on both the Consumer and the Business which aren't available from traditional credit data sources. The User is then prompted to answer these “out of wallet” questions pertaining to the Consumer and Business. Accuracy of the responses by the User determines if the User is in fact the Consumer and legal representative of the Business.

If the User does not pass one of the above 4 verifications, the User's IP address is searched against a list of IP addresses known to have multiple online loan applications in a predetermined period of time. If it is determined that this User has submitted too many online applications that fail to pass the KYC process, the application is failed. If it is determined that this User has not submitted too many online applications, the User is redirected towards the ‘Submission of consumer and business information’ step again so that they may edit information submitted to the application.

The following is an illustrative example of the steps of the KYC Process:

Consumer and Business Information is Entered:

Company Name: XXXX

Doing Business As (DBA): XXXX

Business Tax ID: YYY-YYY-YYY

Owner Name: XXXX

SSN: YYY-YYY-YYYY

Owner Date of Birth: 11/19/1970

Business Inception Date: 08/01/1996

Business State: GA

Industry: Automotive Body, Paint, and Interior Repair and Maintenance

SIC Code: 7532

NAICS Code: 811121

Verification of Consumer as a legal representative of the Business:

For this step, the Lexis Nexis Business Instant ID report was queried and the following information was returned.

Representative Relationship Score (max of 50): 50

Business Verification Score (max of 50): 50

Comprehensive Owner Verification Score (max of 50): 40

Bankruptcy Filings (Business): 0

Unreleased Judgment/Liens Filings (Business): 0

Released judgment/Liens Filings (Business): 0

Overall Status: Auth. Rep. is likely an officer or employee of business of business confirmed by public records.

Further, this information was used to predict the Business+Consumer Relationship score for this loan application. The score returned was:

Business+Consumer Relationship Score: 98%

Due to the high score returned by the KYC algorithm, no need was seen to pull further Business+Consumer Relation data sources for the purposes of fulfilling KYC requirements.

Verification of Consumer information:

For this step, the Equifax credit bureau Consumer credit report was queried and the following information was returned.

Credit Score (max of 850): 718

Fraud Warning: No

Date of Birth: 11/19/1970

File Since Date: 10/07/1988

Age of Oldest Account: 274

Age of Oldest Revolving Account: 121

Number Inquires w/in 3 Months: 0

Number Inquires w/in 12 Months: 0

Number Inquires w/in 24 Months: 2

Further, this information was used to predict the Consumer Verification score for this loan application. The score returned was: Consumer Verification Score: 88%.

Due to the high score returned by the KYC algorithm, no need was seen to pull further Consumer data sources for the purposes of fulfilling KYC requirements.

Verification of Business information:

For this step in the algorithm, the Experian credit bureau Business credit report was queried and the following information was returned.

On Deck Risk Score 1 (max of 850): N/A

On Deck Risk Score 2 (max of 850): N/A

Business Inception Date: N/A

Number of Employees: N/A

Bankruptcy Filings Last 24 Months: N/A

Age of Oldest Trade: N/A

Age of Oldest Non Financial Trade: N/A

Age of Oldest Financial Trade: N/A

Due to the lack of information contained in the Experian report, the Equifax credit bureau Business credit report was also queried and the following information was returned.

On Deck Risk Score 1 (max of 850): 493

On Deck Risk Score 2 (max of 850): 524

Business Inception Date: 08/01/1996

Number of Employees: 5-25

Bankruptcy Filings Last 24 Months: 0

Age of Oldest Trade: 149

Age of Oldest Non Financial Trade: 149

Age of Oldest Financial Trade: 81

Further, this information from Experian and Equifax along with information reported from Lexis Nexis was used to predict the Business Verification score for this loan application. The score returned was: Business Verification Score: 93%

Due to the high score returned by the KYC algorithm, no need was seen to pull further Business data sources for the purposes of fulfilling KYC requirements. Verification of relationship between User and Consumer/Business:

For this step in the algorithm, the IDology identity verification report was queried and the user was able to answer correctly the challenge questions relating to out of wallet information of the Consumer.

Due to the combination of the 3 scores generated in previous steps and the results of the IDology test, no need was seen to further establish the identity of the User and his/her relationship to the Consumer/Business.

At this point, it was deemed that the application had completed KYC requirements and was passed.

Although the present invention has been described with reference to preferred embodiments, workers skilled in the art will recognize that changes may be made in form and detail without departing from the spirit and scope of the invention.

We claim:

1. A process for verifying that the user submitting information to an online application portal for a business is the owner and legal representative of that business, comprising:
receiving basic information about the user and the business;
querying multiple data sources in order to obtain records on the user, the legal representative of the business, the owner of the business and the business;
calculating a first score which predicts the likelihood of the user being the legal representative of the business;
calculating a second score which predicts the likelihood of the user being the owner of the business; and
calculating a third score which predicts the likelihood that the business is an active business.

2. The process of claim 1, wherein the first score represents an accumulation of scores from a plurality of data sources.

3. The process of claim 1, wherein the second score represents an accumulation of scores from a plurality of data sources.

4. The process of claim 1, wherein the third score represents an accumulation of scores from a plurality of data sources.

5. The process of claim 1, wherein the second score is only calculated if the first score meets a predetermined threshold.

6. The process of claim 6, wherein the third score is only calculated if the first and second score meet predetermined thresholds.

7. The process of claim 1, further comprising the step of:
querying additional data sources to obtain additional information about the business;
prompting the user to answer questions based on the additional information.

8. The process of claim 7, further comprising the step of:
completing a know your customer verification if all three scores are above a predetermined threshold and the answers to the a predetermined number of questions is correct.

9. The process of claim 8, further comprising the steps of:
determining the user's IP address;
searching the user's IP address against a list of IP addresses known to have multiple online applications in a predetermined period of time; and
failing the online application if there is a match.

10. The process of claim 9, further comprising the step of allowing the user to submit additional information if there is not a match.

11. The process of claim 1, wherein the information is received via a network from the user's computing system.
